(19) United States
(12) Patent Application Publication
(10) Pub. No.: US 2007/0228680 A1
(43) Pub. Date: Oct. 4, 2007

(54) Modular Workstation

(75) Inventors: David A. Reppert, Kingston, PA (US); Craig F. Orlove, Mountaintop, PA (US); David J. Salus, Shavertown, PA (US); James Janick, Hanover Twp., PA (US); Scott Shinkle, Bear Creek Twp., PA (US); Robert R. Steele, Sweet Valley, PA (US)

Correspondence Address: HARNESS, DICKEY & PIERCE, P.L.C., P.O. BOX 828, BLOOMFIELD HILLS, MI, 48303, US

(73) Assignee: METRO INDUSTRIES INC., Reno, NV (US)

(21) Appl. No.: 11/695,326

(22) Filed: Apr. 2, 2007

Related U.S. Application Data
(60) Provisional application No. 60/788,840, filed on Apr. 3, 2006.

(51) Int. Cl. B62B 3/00

(52) U.S. Cl. 280/47.35

(57) ABSTRACT

A point of application workstation is disclosed and generally includes a base unit, a power unit, a support unit, a work surface and storage unit, a monitor assembly and a control unit. Extending upward from the base unit is the support unit which carries the work surface and storage unit, control unit and monitor assembly. The workstation may be stationary or mobile. The power unit is housed in the base unit. The work surface and storage unit may be configured with a variety of storage solutions for any of a number of work environments and tasks. The work surface and storage unit may house a computer that is integrated into the workstation. The control unit provides a measure of security for the workstation by allowing access to the workstation and control over its features only by authorized users.

### CROSS-REFERENCE TO RELATED APPLICATIONS

This application claims the benefit of U.S. Provisional Application No. 60/788,840, filed on Apr. 3, 2006. The disclosure of the above application is incorporated herein by reference.

### FIELD

The present disclosure relates to a modular workstation and, more particularly, to a point of application workstation employing a computer, a pull-out keyboard tray or drawer, a modular drawer and cassette system, a height-adjustable support device, and a rechargeable and modular power supply.

### BACKGROUND

The statements in this section merely provide background information related to the present disclosure and may not constitute prior art.

Mobile storage assemblies and mobile computer workstations are well known in the art. Generally, in such mobile workstations, storage space may be provided in the form of shelves or drawers for storage of various work-related items. Additionally, to facilitate a computer and related components and peripherals, an open, retractable keyboard shelf may be provided to store a computer keyboard when not in use.

One type of known modular shelving system is disclosed in U.S. Pat. No. 5,797,503 (Stevens et al.), which is assigned to the assignee of the subject invention, and hereby incorporated by reference. The modular shelving system discloses open, retractable wire shelves supported by vertical support posts at each corner. The support posts may be equipped with vertical slots for receiving mounting hardware, while the bottom shelf may be equipped with an anti-tip leg assembly.

U.S. Pat. No. 5,915,803 (Daugherty et al.), which is assigned to the assignee of the subject invention and hereby incorporated by reference, discloses a modular storage and support assembly that includes vertically disposed support posts. The support post has an extended tubular body and a plurality of symmetrically spaced, radial flanges running the length of the tubular body. A slot is defined between each flange for receiving vertical panels.

U.S. Pat. No. 5,651,596 (Carlson et al.), which is assigned to the assignee of the subject invention and hereby incorporated by reference, discloses a modular drawer with a variable depth. The modular drawer has a drawer frame with a back panel, first and second side panels and a front panel secured together to form an open, bottomless frame. A drawer insert, having vertical walls and a bottom surface, is supported within the drawer frame.

U.S. Pat. No. 5,716,116 (Carlson et al.), which is assigned to the assignee of the subject invention and hereby incorporated by reference, discloses a modular storage and support structure that, when fully assembled, forms a utility cabinet that can be swingingly secured to each lateral side of the assembly.

U.S. Pat. No. 5,803,559 (Carlson et al.), which is assigned to the assignee of the subject invention and hereby incorporated by reference, discloses a lockable modular storage and support assembly utilizing a locking bar within a corrugated interior surface.

U.S. Pat. No. 5,805,075 (Carlson et al.), which is assigned to the assignee of the subject invention and hereby incorporated by reference, discloses a modular storage and support assembly utilizing vertical support posts. An electronic control system controls a security system for locking and unlocking the modular storage and support assembly.

U.S. Pat. No. 6,158,830 (Johnson et al.), which is assigned to the assignee of the subject invention and hereby incorporated by reference, discloses a lock assembly for use in an enclosed structure housing a locking bar having a plurality of locking fingers. Furthermore, a lock arm mechanism is disclosed, which has a lock arm and a lock arm mounting assembly for mounting the lock arm mechanism in the enclosed structure. The lock arm causes a rigid finger on the locking bar to be raised and lowered and in doing so raises and lowers the locking bar.

U.S. Pat. No. 5,673,983 (Carlson et al.), which is assigned to the assignee of the subject invention and hereby incorporated by reference, discloses a medication cart featuring a frame assembly formed from a plurality of vertical support posts and wall panels secured to the posts. Each support post has a plurality of equally-spaced, radially extending flanges running the longitudinal length of the post. The medication cart contains, in addition to an array of drawers and bins, a multi-level cassette assembly. An internal locking mechanism secures the cassette assembly when it is positioned in the medication cart, and an external locking mechanism secures the bins of the cassette assembly outside of the medication cart.

While the above modular storage and support assemblies have proven satisfactory for their purposes, further improvements in such assemblies would be beneficial. For example, in one application it is desirable to have a workstation incorporating a modular storage assembly, such as one having a lockable drawer and cassette system suitable for storing and easily retrieving the various contents stored. In one anticipated workstation application, such stored contents may include pharmaceuticals, for example. In addition, the workstation would be capable of housing a computer, would optionally be mobile, would be able to be secured to limit a user's access to the workstation and any stored contents, and would provide flexibility in its ergonomics to accommodate the working preferences of its various users.

### SUMMARY

In accordance with the teachings of the present disclosure, a point of application workstation is disclosed. The workstation generally has major components consisting of a base unit, a power unit, a support unit, a work surface and storage unit, a monitor assembly and a control unit.

The base unit provides a foundation for the workstation. The base unit has a base cover and a base pan that together define a cavity within which a power unit for the workstation is housed. The base cover provides protection for the power unit. In this regard, it is desirable that the base cover prevent potentially damaging contaminants, such as liquids, from reaching the power unit.

The base unit may be optionally configured to provide for a stationary workstation or a mobile workstation. In one configuration, the base unit may rest upon legs and/or feet mounted beneath its bottom surface, thereby providing a generally stationary workstation. Alternatively, or in addition to the legs or feet, the workstation may include wheels mounted beneath its bottom surface, such as swiveling casters, for example. The inclusion of wheels enables the workstation to roll and easily be moved. If equipped with wheels, releasable wheel locks may also be included to enable the user to selectively prevent the wheels from rotating. In such a configuration, a workstation is provided that can easily be alternated between states of free and restricted mobility.

The workstation includes a power unit for providing electrical power to the workstation and its accessories and/or peripheral components. The power unit is housed in the base unit. The power unit may comprise a charging system and one or more rechargeable batteries. The charging system receives AC power from, for example, a wall outlet, and delivers DC power to the batteries to charge them. An advantage provided by the power unit of the invention is that it may operate to power the workstation independent of the condition or presence of the batteries. For example, the power unit is able to power the workstation even during periods when the charge level of the batteries is low and/or the batteries are being recharged. In addition, the power unit is able to power the workstation even if the batteries were defective or removed from the power unit. In such situations, the power unit may be plugged into an AC power source to provide the workstation with its full functionality.

The support unit is mounted to, and extends vertically from, the base unit. The work surface and storage unit, control unit and monitor assembly are, in turn, mounted to the support unit.

The support unit may be vertically adjustable to control the position of work surface and storage unit, control unit and monitor assembly to suit a wide range of user preferences under a variety of working conditions, such as standing or being seated, for example. Alternatively, the support unit may be fixed vertically such that it does not provide for any adjustment. An adjustable support unit may, for example, comprise a single-leg, linear actuator. Such a linear actuator may comprise two longitudinally extending components, one telescopingly nested within the other to permit relative movement therebetween. The linear actuator may be displaced vertically up and down as desired by the user. Such adjustment may be accomplished by the user under power supplied by the workstation such as, for example, by an electrically-driven gear motor operating under control of the user via an input on the control unit. Alternatively, adjustment may be accomplished manually by the user with the aid of a hydraulically or pneumatically assisted bar gas spring, or other types of balancers.

Wiring for the workstation, such as power cords and communication cables, for example, may be routed through the support unit. This feature enables the workstation to have a cleaner, more efficient appearance, helps avoid the inadvertent disconnection of cords or cables by the user and protects the cords and cables from excessive wear.

The work surface and storage unit is mounted to the support unit above the base unit. The work surface and storage unit provides the workstation with ample working and storage space. In addition, the storage space may be configured with a variety of modular storage solutions to enable the workstation to be suitable for any of a number of work environments and tasks.

The top of the work surface and storage unit includes a generally flat work surface that provides a space where the user may perform the general work duties that are associated with the use of the workstation. At its opposite end, located generally at or near the bottom of the unit, the work surface and storage unit has a computer compartment. The computer compartment is provided to house a computer, such as a laptop, for example, that may be integrated into the workstation. The computer compartment may be locked to deny physical access to the computer for security purposes. When the computer compartment is unlocked, a hinged bottom panel provides access to the computer.

Located above the computer compartment and beneath the work surface in the work surface and storage unit is a storage compartment. The storage compartment incorporates a universal mounting apparatus and provides the capability to integrate any of a variety of modular storage solutions into the workstation, including any combination of drawers, trays, shelves, and storage cassettes, among others.

As one example, a removable storage cassette assembly which houses multiple slide-out drawers or cassette bins that are suited for the storage and organization of any of a variety of items, such as that disclosed in U.S. Pat. No. 5,673,983, may be integrated into the workstation. Such a configuration may be suitable for use in a workstation adapted for medical point of care (POC) service. In this regard, the workstation may be configured for the storage and dispensing of pharmaceuticals and/or medical items, like medications, syringes, bandages, gauze, tape, and the like. The cassette assembly and/or cassette bins may be easily removed from the workstation to be re-supplied. As such, the entire workstation does not have to be out of use during such periods. By having more than one cassette assembly, the advantages of the modularity of the workstation become apparent.

In another configuration, the storage compartment houses a keyboard tray, located just below the work surface, upon which a computer keyboard may be located. The keyboard tray may be pulled out during use, much like a drawer, or pushed into the storage compartment when in its stowed position. The keyboard tray is not intended to prohibit access to the computer keyboard. In another embodiment, the storage compartment houses a lockable, enclosed keyboard compartment as an alternative to the keyboard tray. In its use position, the keyboard compartment is extended from the storage compartment so the computer keyboard is accessible. In its stowed position, the keyboard compartment is pushed into the storage compartment where it may be locked to prevent access to the computer keyboard.

An additional feature of the work space and storage unit is the inclusion of an auxiliary work surface located just beneath the work surface. The auxiliary work surface comprises a pull out tray that is capable of being extended from either the left or right side of the work surface and storage unit. The auxiliary work surface provides the user with additional flat work space, and may accommodate workstation peripherals, such as a computer mouse, for example. Because it may be alternatively located on either the right or left of the workstation, the auxiliary work surface provides additional flexibility for the user to configure the workstation to his or her preferences.

A monitor assembly mounts on top of the support unit and above the work surface and storage unit. Like the support unit, the monitor assembly enables the hidden and protected routing of wiring for the workstation like power cords and communication cables. The monitor may be mounted to the monitor assembly with monitor bracketing to permit the monitor to rotate 360 degrees in a vertical plane, or in planes at an angle to the work surface.

The control unit may alternatively be disposed within the monitor assembly or in the work surface. The control unit provides a measure of security for the workstation by allowing access to the workstation only by authorized users. In this regard, the control unit enables an authorized user to gain physical access to the workstation's work surface and storage unit and the items stored therein, such as by enabling the user's control over a variety of the workstation's locking features. Alternatively, the control unit may also provide authorized users with electronic access to an onboard computer, the computer keyboard, login authentication to the computer and/or a computer network and access to the computer's peripherals, if any. The control unit also includes a variety of indicators for the workstation's user, such as LEDs that indicate the status of the power unit or its components. For instance, the LEDs may indicate the level of charge held by the power unit or the condition of its batteries. The control unit may also enable the user to manage any user-adjustable features of the workstation.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a modular and mobile point of application workstation depicting a modular cassette bin and cassette assembly according to teachings of the invention;

FIG. 2 is a side perspective view of a modular and mobile point of application workstation depicting storage drawers according to teachings of the invention;

FIG. 3 is a perspective view of a modular and mobile point of application workstation with its cassette assembly and wheels removed according to teachings of the invention;

FIG. 4 is a perspective rear view of a modular and mobile point of application workstation according to teachings of the invention;

FIG. 5 is a perspective rear view of a modular and mobile point of application workstation according to teachings of the invention;

FIG. 6 is a perspective side view of a modular and mobile point of application workstation with its bottom pan lowered according to teachings of the invention;

FIG. 7 is a perspective rear view of the base of a modular and mobile point of application workstation according to teachings of the invention;

FIG. 8 is a perspective bottom view of the base of a modular and mobile point of application workstation depicting the location of power supply and charging system vents and an exhaust fan in the base pan according to teachings of the invention;

FIG. 9 is a perspective bottom view of the base of a modular and mobile point of application workstation with the base pan removed to reveal the void where a power source and charging system reside during operation according to teachings of the invention;

FIG. 10 is a perspective front view of a modular and mobile point of application workstation with the base pan removed to reveal one of the fasteners which secures the base pan during base pan installation according to teachings of the invention;

FIG. 11 is a perspective bottom view of the base of a modular and mobile point of application workstation with the base pan removed to reveal a battery power source and charging system according to teachings of the invention;

FIG. 12 is a perspective bottom view of the base of a modular and mobile point of application workstation with the base pan and battery power source removed to reveal a battery cover according to teachings of the invention;

FIG. 13 is a perspective front view of a modular and mobile point of application workstation with the base portion depicted in an exploded view according to teachings of the invention;

FIG. 14 is a perspective front view of a modular and mobile point of application workstation with its cassette assembly and wheels removed and its linear actuator partially extended;

FIG. 15 is a perspective view a computer compartment depicting the location of a computer and a power converter according to teachings of the invention;

FIG. 16 is a perspective front view of a computer compartment and an associated locking mechanism according to teachings of the invention;

FIG. 17 is a bottom perspective view of a computer compartment and an associated locking mechanism according to teachings of the invention;

FIG. 18 is an internal side view of a computer compartment depicting a gear drive motor component for the locking mechanism of the work surface and storage unit of the workstation according to teachings of the invention;

FIG. 19 is an internal side view showing additional components of the cassette assembly and drawer locking mechanism, with a cover panel removed for clarity, according to teachings of the invention;

FIG. 20 is an enlarged internal side view also showing the cassette assembly and drawer locking mechanism according to teachings of the invention;

FIG. 21 is a perspective front view depicting the internal cavity of a modular and mobile point of application workstation with its drawers removed, the pull out computer keyboard tray, and the computer compartment depicting the location of a computer, a DC/DC converter and an exhaust fan;

FIG. 22 is a perspective front view of the internal cavity of the mobile workstation with its drawers removed, depicting corrugations that guide the drawers for modular storage;

FIG. 23 is a perspective top view of the mobile workstation with its top surface removed to reveal a pull out tray and support posts;

FIG. 24 is a perspective side view depicting a pull out keyboard tray, a pull out storage drawer, an upper work surface, and a monitor assembly of a modular and mobile point of application workstation according to teachings of the invention;

FIG. 25 is a front perspective view of the monitor assembly with its front cover removed of a modular and mobile point of application workstation according to teachings of the invention;

FIG. 26 is a perspective front view depicting the monitor mounting assembly in an exploded view of a modular and mobile point of application workstation according to teachings of the present disclosure; and

FIG. 27 is an exemplary view of the point of application workstation configured for use in a medical environment.

### DETAILED DESCRIPTION

The following description is merely exemplary in nature and is not intended to limit the present disclosure, application, or uses. It should be understood that throughout the drawings, corresponding reference numerals indicate like or corresponding parts and features.

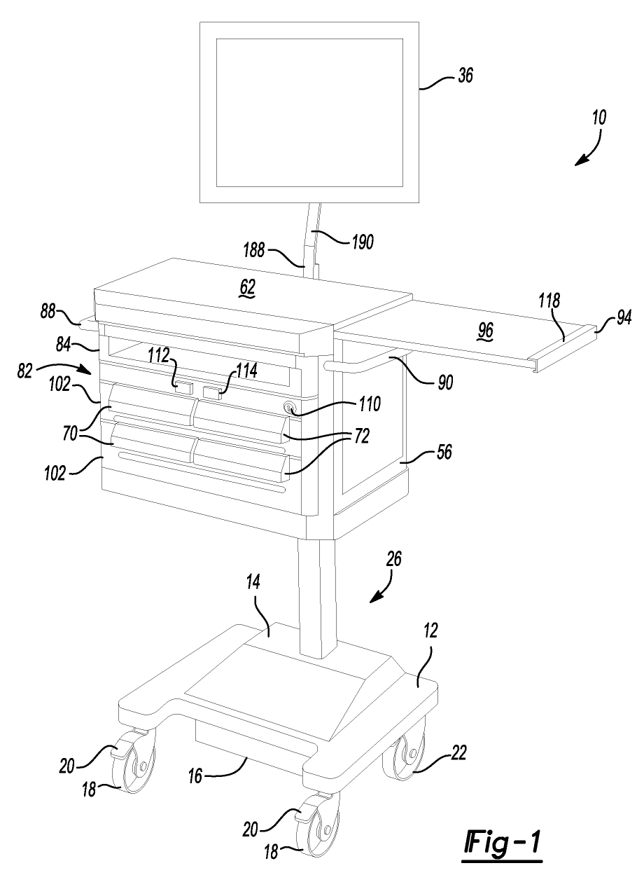

FIG. 1 is a perspective view depicting a point-of-application (“POA”) workstation 10 according to the invention. In the discussion of the POA workstation 10 that follows, the POA workstation 10 may be referred to as a “workstation” 10 for ease of reference, and because the workstation 10 may be applicable to a variety of applications in a variety of industrial settings and other work environments.

One type of point-of-application workstation which is contemplated herein is a point-of-care (“POC”) workstation, which may be specifically adapted for use in a medical facility, such as a hospital. Other settings in which the workstation may be utilized consist of, but are not limited to, inventory control applications, maintenance applications, diagnostic applications, food service applications, quality control applications where, for instance, sampling and/or statistical analyses may take place, loading dock shipping and receiving applications, manufacturing assembly/parts tracking applications, pharmaceutical manufacturing and/or dispensing applications, or portable point-of-sale location applications.

In a workstation 10 equipped with an on-board computer, real time information exchange at a point of task may be accomplished. In such applications, selections, decisions, corrections, detections and data entry are all possible with the workstation 10 of the invention.

When the workstation 10 is used to its fullest advantage, general areas such as safety, control, and authorization are improved or made more efficient. Because real time records are capable of being recorded, redundancy in data or tasks may be reduced. For instance, information may be immediately and accurately exchanged, or when work is performed, charges associated with such work may be immediately issued. To accomplish such real-time information exchange, the workstation 10, and more specifically, the on-board computer system, may communicate, for example, with a central computer or a local area network for the facility within which the workstation 10 is utilized.

Such communications may be by traditional, wired communications means or may be by wireless communications. Various wireless communications protocols may be incorporated into and used with the workstation 10 and its on-board computer system. For instance, well-known wireless communications protocols 802.11a, b, g, and/or e may be employed. In addition, other wireless protocols such as Bluetooth® may be used. Any peripherals associated with the communications, such as network adapters and routers, for example, may be located within the workstation 10 or integral with the workstation's on-board computer.

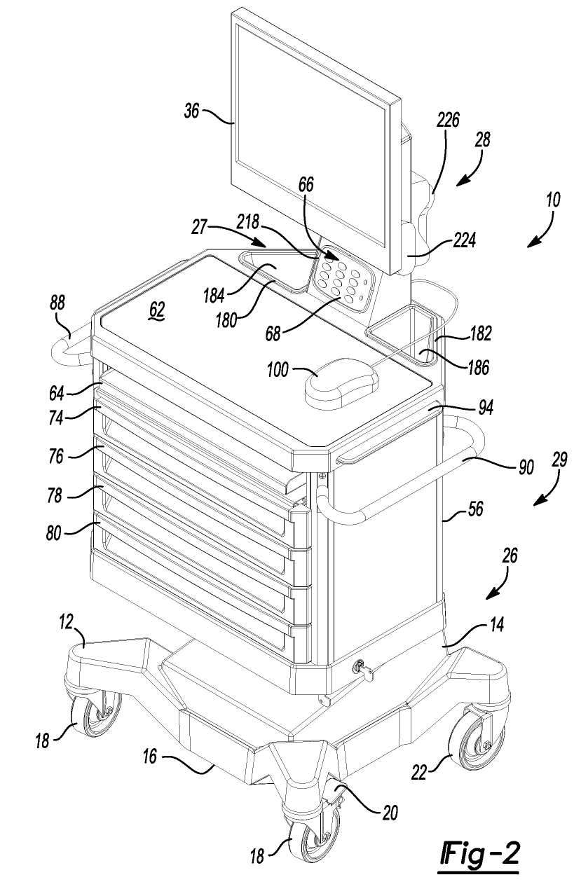

With reference to FIGS. 1-3, the structure of the workstation 10 is generally depicted as having an aspect ratio such that the workstation 10 width is greater than its depth. That is, when a user is standing in front of the workstation 10, such as when using the computer, the width of the workstation will be wider than its depth. Continuing, the workstation 10 rests on a base unit 12, which is generally of a two-piece construction and comprises a base cover 14 and a base pan 16. With reference to FIG. 2, the base cover 14 may have two front wheels 18 and two rear wheels 22 attached to its underside portion, beneath the base unit 12. The front wheels 18 may each have a lock pedal 20, while the rear wheels 22, as depicted, do not have locks; however, the inclusion, arrangement and locking capabilities of any wheels are not limited to such and may be altered. Additionally, swiveling or non-swiveling wheels may be used in any combination to arrive at the desired motion and maneuvering requirements of the workstation 10.

Alternatively, the workstation 10 does not have to be equipped with wheels that make the workstation 10 mobile and easily transportable. In such a configuration, the workstation 10 may have rigid legs or feet installed within, or as an integral part of, the base cover 14 or base pan 16. In such a situation, the workstation 10 would function primarily as a stationary workstation, although the workstation 10 may still be slid or lifted to be moved or transported whenever and however desired.

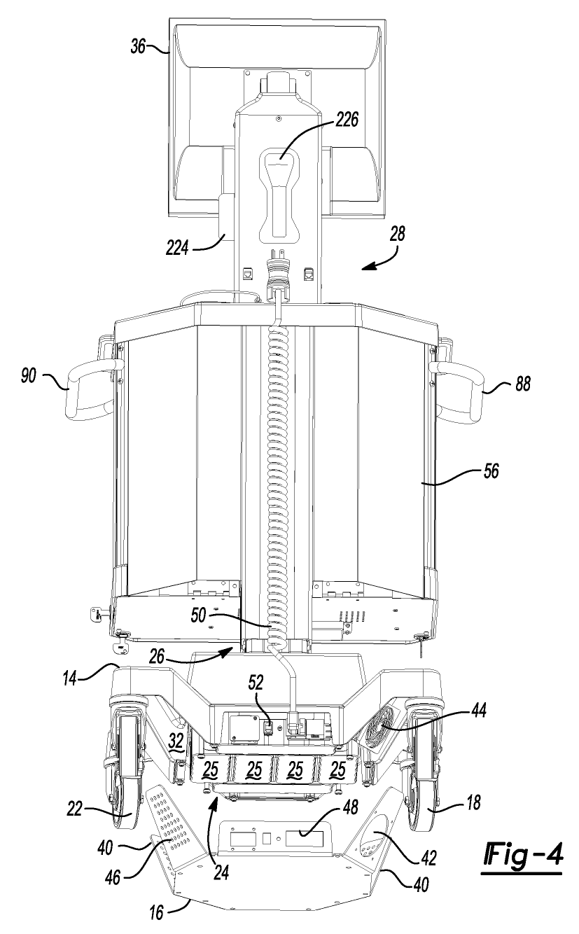

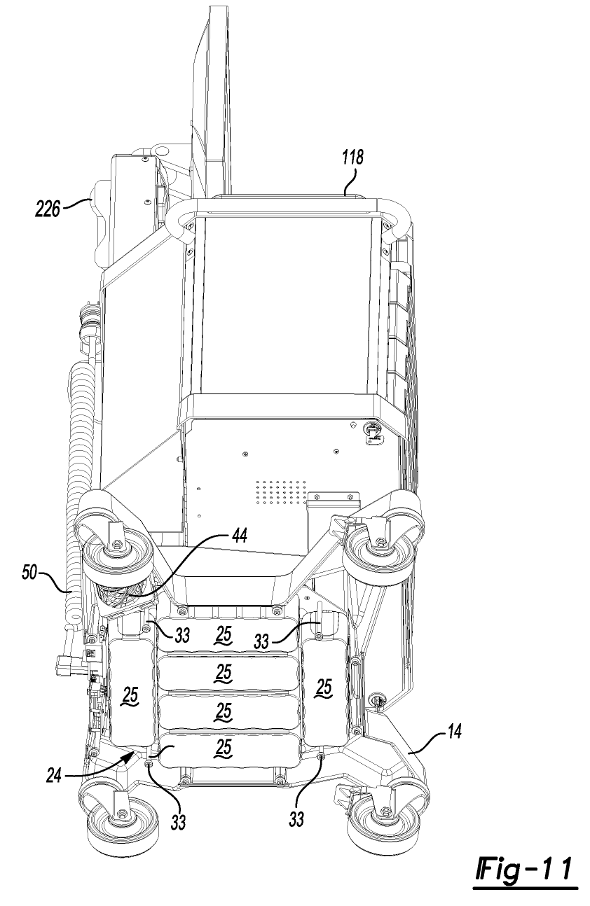

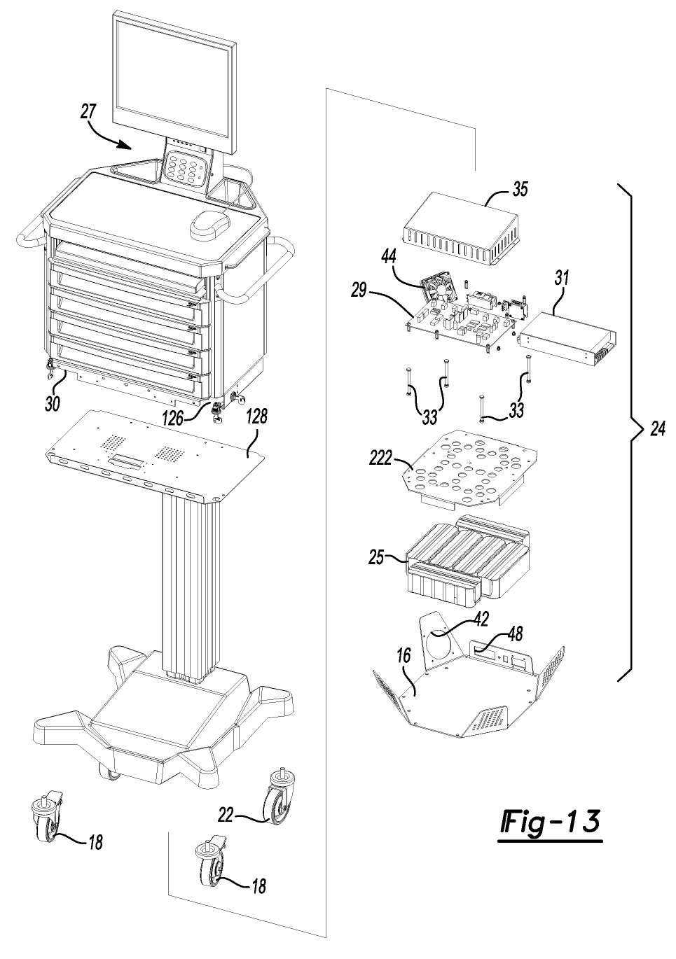

As best depicted in FIG. 13, a power unit 24, comprising, for example, a charging system 29 and one or more rechargeable batteries, resides within an interior cavity of the base unit 12. The power unit 24 is housed in the cavity created by the juncture of the base cover 14 and base pan 16. The power unit 24 provides a compact and modular power supply to all on-board electrical components, such as but not limited to a computer, monitor, peripherals, a locking motor, and status light or LEDs. In one configuration, the power unit 24 comprises a plurality of independently replaceable battery modules 25 coverable by a battery cover 222. Each battery module 25 contains a plurality of batteries (for example, “D” sized nickel metal hydride batteries) and a charging system 29 which efficiently charges the batteries while maximizing the useful life of the batteries. The power unit is scalable (e.g., it can be expanded or contracted in size and power) by increasing or decreasing the number of battery modules 25 incorporated into the power unit. With reference to FIGS. 4 and 11, one example of a battery pack for use in the invention includes six (6) battery modules 25, each having twelve (12) “D” sized nickel metal hydride batteries. As previously discussed, if supplied with AC power via a power entry module 31, the power unit 24 of the workstation 10 is capable of providing DC power to the workstation 10, the on-board computer and any peripherals notwithstanding the charge level or condition of its batteries. The charging system 29 may be covered by a cover 35.

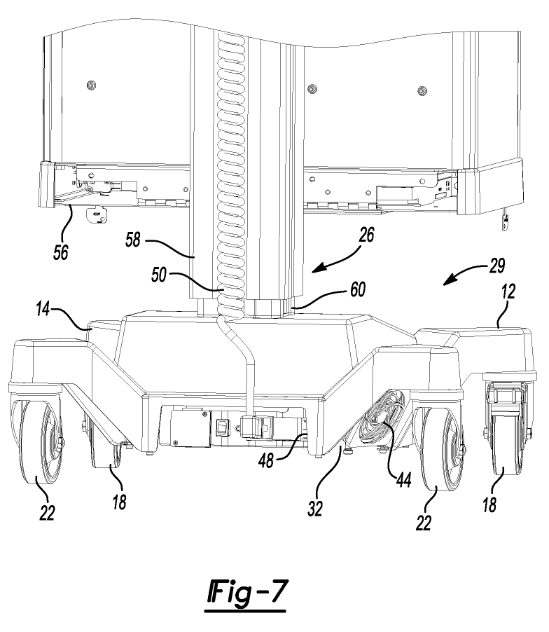

With reference to FIGS. 2 and 7, the necessary wiring for the workstation, such as power supply cords, communication cables, and the like (not specifically shown), for supplying power to a computer 30 and monitor 36, and for monitoring the status of the power unit, as examples, are located within the base unit 12 and routed throughout the support unit 26 and monitor assembly 28, as required. Because the support unit 26 telescopes, the workstation 10 is capable of collapsing to a height to facilitate easy transport. Likewise, the workstation 10 is capable of vertically extending to facilitate the preferences and working styles of various users, such as users who may be seated in front of the workstation.

The power unit 24 and method for its operation and use provides for numerous beneficial features and advantages. For instance, with reference to FIG. 2, a battery gauge, located on the control unit 27, may provide a user-detectable output such as, for example, a bank of six or more light emitting diodes (LEDs) representing various stages of battery charge such as 100%, 80%, 60%, 40%, 20%, and CHECK BATTERY. A CHECK BATTERY feature may provide a visual or audible indication to a user if a problem is detected with any of the battery modules or control circuits. The audible indication may be made with a speaker within a wall of the monitor assembly or within the monitor assembly itself. Each battery module 25 is chargeable by a separate control circuit. Each control circuit includes a fuse to disable the charging system in the event of any change in current caused by a battery failure, short circuit, or the like. The fuse may be either a one-shot device or resettable, as desired. In addition, each control circuit includes a user accessible visual or audible indicator, such as an LED that flashes, to provide some user detectable indication if a problem with its corresponding battery module is detected in the charging system.

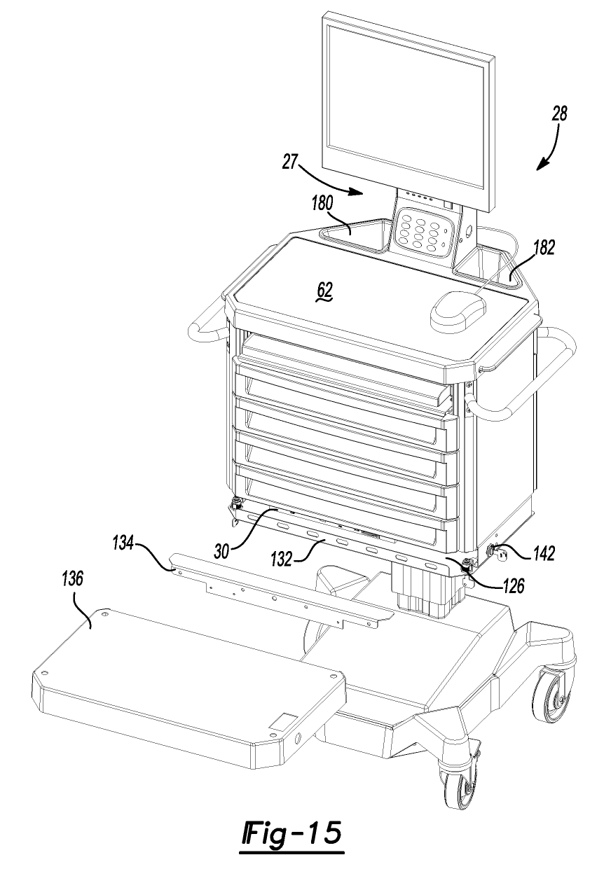

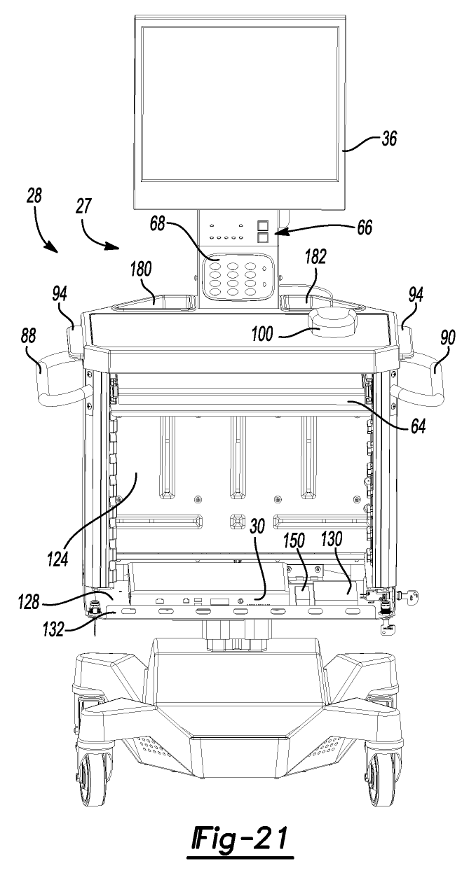

With reference to FIG. 4, the power unit 24 is adaptable to operate under 110 VAC or 240 VAC and is capable of operating even if fewer than the total number of battery modules 25 are operational, for example, if there is a failure of one or more of the battery modules. The system may also include one or more DC/DC converters (see e.g. FIG. 21) capable of monitoring output voltage to devices running off of the power supplied by the battery pack. Each DC/DC converter 130 (see, e.g., FIGS. 15, 20 and 21) includes a fuse to safeguard against problems related to voltage or current that may occur with any of the devices. A DC/DC converter 130 includes a switch or other means for changing (e.g., an integrated circuit) the DC voltage output to accommodate devices having different DC voltage requirements. A fuse and a temperature sensor are associated with each battery module 25.

The battery charging system is capable of monitoring the temperature of the battery modules 25 and/or batteries and adjusting the charging conditions in response thereto. The battery charging system operates to maximize the life of the battery modules and/or batteries and still maintain desirable charging times. For example, the battery modules and/or batteries are fully rechargeable in 4 hours while enabling a battery life of 1-2 years. Finally, the battery charging system is capable of recharging battery modules and/or batteries whether or not devices running off of the power supplied by the battery modules 25 are operating.

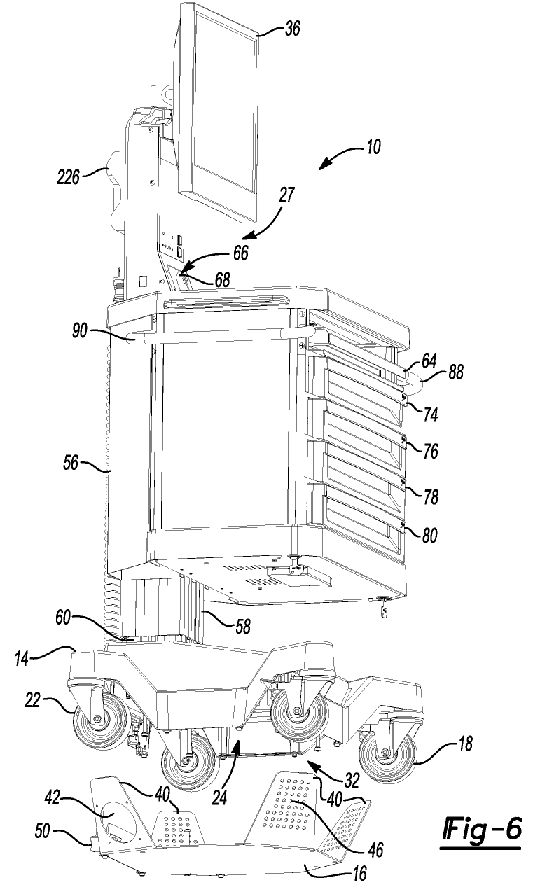

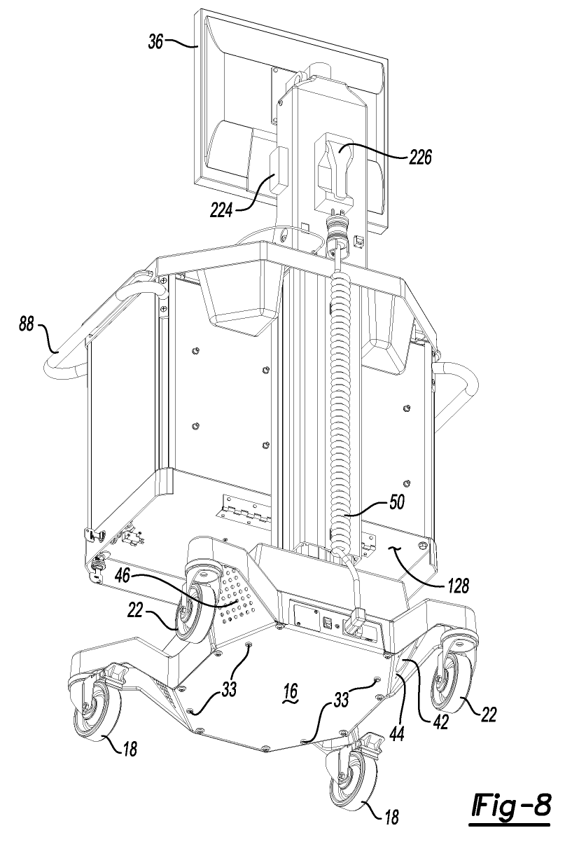

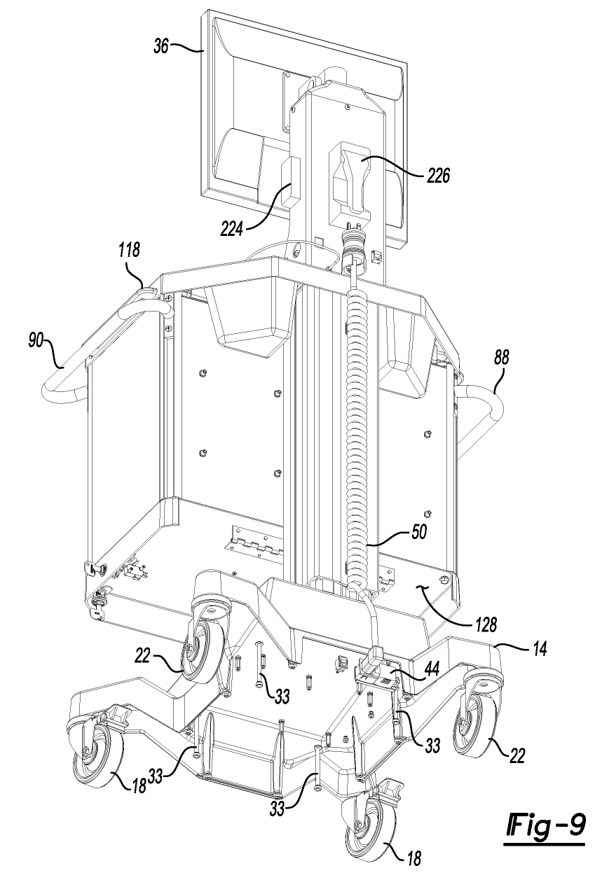

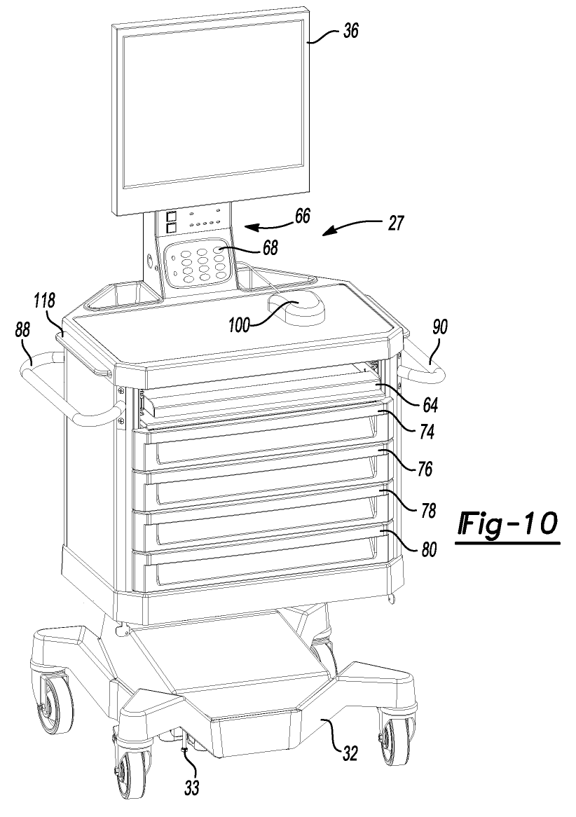

Referring now to the base pan 16 in FIGS. 6 and 8, its scalloped shape reveals multiple petals 40. Each petal 40 has holes in it that serve a function. For instance, the single petal hole 42 may be used to house an exhaust fan 44 (FIGS. 7, 11 and 12) for cooling the power unit 24 stored within the base unit's interior cavity 32 (FIG. 6), while the group of holes 46 serves as an air intake to facilitate cooling of the power unit 24. The wiring (not shown) may connect the power unit 24 to a computer 30 and monitor 36, as well as various other devices and peripherals associated with computing and other systems and functions of the workstation 10 (e.g., via its DC/DC converter 130). For instance, such wirings, may run from the power unit 24 in the base unit 12, through the stalks 58, 60 of the support unit 26, to the computer 30 and DC/DC converter 130 in the work surface and storage unit 56, to the touch pad 68 of the monitor assembly 28, and finally to the monitor 36 at the top of the monitor assembly 28. FIGS. 9-11 depict a plurality of fasteners 33 which secure the base pan 16.

Continuing now with more specific reference to FIG. 4, a rear view of the base pan 16 depicts a rear base pan hole 48. The hole 48 may be used by an electrical cord 50 to gain access to the power unit 24 housed within the base unit's interior cavity 32, such as for electrically recharging the battery modules 25. Additionally, the rear base pan hole 48 may provide access to a main power switch 52 used for long term power shut-off or for servicing the workstation 10. Such a power switch 52 is separate from any power switching performed by the control unit 27 (see, e.g., FIG. 2).

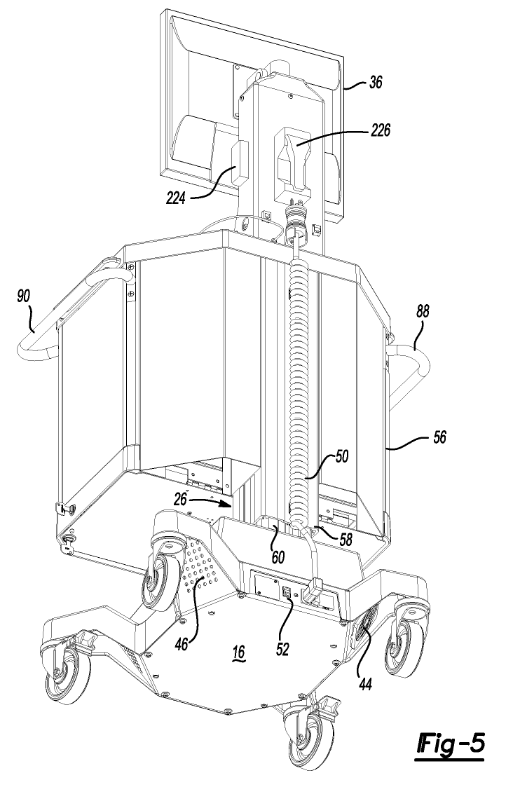

Manufacture of the base unit 12, as depicted in various perspectives in FIGS. 1-10, may be accomplished by any of a variety of methods. The base cover 14 may be a cast structure, such as cast aluminum, while the base pan 16 may be a stamped steel component; however, the manufacturing process for making such pieces is not limited to casting and stamping. Although the base cover 14 has been described as a cast piece, it may be made by any suitable manufacturing process, such as stamping or molding from metal or any of a variety of plastics. Similar to the base cover 14, the base pan 16 may be stamped from sheet steel or other metal, cast from metal, or formed from plastic.

As depicted in FIG. 1, and throughout the figures, the base unit 12, supports the support unit 26. Referencing FIGS. 8-13, the base unit's interior cavity 32 is designed with the base cover 14 and base pan 16 such that the power unit 24 may be accessed by lowering the base pan 16, which may be secured to the base cover 14 with fasteners 33 (FIG. 8) such as screws, bolts, or like fasteners.

Turning now to FIGS. 1-7 and 14, the workstation 10 has a suitable support unit 26, which may optionally provide for vertical adjustability of the workstation. A vertically adjustable support unit 26 is generally a two-piece linear actuator to which is mounted the work surface and storage unit 56. The linear actuator is generally a dual-piece hollow device in which one linear portion traverses within a second linear portion, one portion having a slightly larger cross-sectional area than the other to permit relative motion between the two pieces. While one portion, the lower portion, for example, mounts to the base unit 12, the upper portion, for example, serves as a mount for the work surface and storage unit 56.

The linear actuator, also called a stalk, is attached to a rear side of the work surface and storage unit 56 and is primarily constructed of two major pieces, an upper stalk 58 and a lower stalk 60. As depicted in FIG. 2, the linear actuator may be recessed within a rear side of the storage unit 56, but may be easily attached to the rear exterior side of the storage unit 56, as opposed to being recessed. The linear actuator is attached to the storage unit 56 from inside of the storage unit 56 using traditional fasteners such as screws or rivets; however, welding or other methods of fastening may be employed.

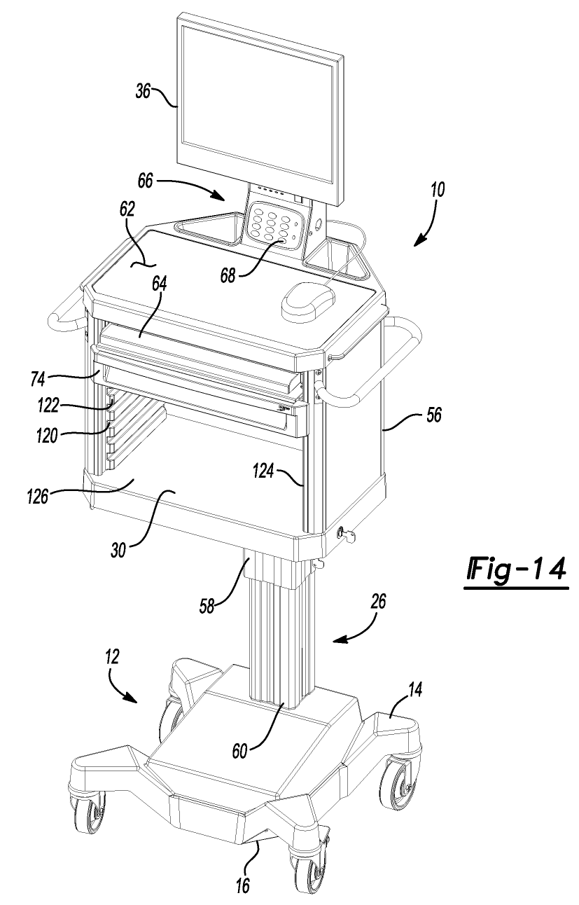

As shown in FIG. 2, the tubular lower stalk 60 traverses within the tubular upper stalk 58, which is slightly larger in cross-section than the lower stalk 60. As depicted in FIG. 14, because of the two-part construction of the linear actuator, the entire work surface and storage unit 56, along with the computer monitor 36, is capable of being raised to a multitude of different heights in order to satisfy most user-desired vertical positioning preferences. For instance, the top surface 62 of the workstation 10 may be vertically adjusted using the linear actuator, so that a user may type on a keyboard (not shown) situated upon the keyboard tray 64 while in a seated position, similar to the height of the keyboard tray 64 depicted in FIG. 2, or in a standing position, similar to the height of the keyboard tray 64 depicted in FIG. 14. FIG. 14 depicts the workstation 10 with its linear actuator in an extended position such as might be utilized by a person standing at the workstation 10 who might type at the keyboard, read the monitor 36, or perform another task on the top work surface 62.

Because the linear actuator is formed of a hollow upper stalk 58 and a hollow lower stalk 60, the necessary power cords and communication wiring may be easily routed from the base unit 12 and into and through the linear actuator. Once in the linear actuator, the wiring may route into the storage unit 56 and/or continue on to the control unit 27, its LEDs 66, and touch pad 68, and the computer monitor 36, as described herein.

Regarding the linear actuator, such may be similar to those known in the art, such as those available from LINAK Corporation of Denmark. Linear actuators available from LINAK Corporation (www.LINAK.com) are hereby incorporated by reference.

Such a linear actuator may be powered by a 12 or 24 volt dc internal gear motor (not shown) to move the upper stalk 58 and lower stalk 60 in a telescoping fashion about a longitudinal axis to adjust the height of the workstation when the user commands such motion via the control unit 27. Alternatively, instead of electrically powered adjustment, the linear actuator may be moved vertically under the manual control of the user with the assistance of a hydraulic or pneumatic device, such as an adjusting bar gas spring, or other types of balancers.

With reference to FIGS. 1 and 2, the work surface and storage unit 56 provides the workstation with ample working and storage space. In addition, the storage space may be configured with a variety of storage solutions to enable the workstation to be suitable for any of a number of work environments and tasks. For example, the work surface and storage unit 56 provides the capability to integrate any combination of drawers, trays, shelves, and storage cassettes and bins, among others.

As depicted in FIGS. 1-3 and 27, as well as various other figures, the work surface and storage unit 56 may house a variety of cassette bins 70, 72 or modular drawers 74-80. The cassette bins 70, 72 are together removable as a unit as a modular cassette assembly 82, or individually removable from the cassette assembly 82. In a medical environment, such as a hospital, the cassette bins 70, 72 are designed to store medical supplies, such as, but not limited to, drugs, medicines, and medical devices, but such cassettes may be used to store any work-related items.

Proceeding with aspects of the work surface and storage unit 56 and with specific reference to FIG. 1, a locking keyboard compartment 84 lies above the cassette bins 70, 72 of the cassette assembly 82. This arrangement is slightly different than the configuration depicted in FIG. 2, in which a non-locking keyboard tray 64 lies above the drawers 74-80.

Continuing with reference to FIGS. 1 and 2, the left side of the work surface and storage unit 56 has a left handle 88, while the right side of the work surface and storage unit 56 has a right handle 90, and together the handles 88, 90 may be used to maneuver the workstation 10.

The work surface and storage unit 56 has a top surface 62 that may be used as a general work surface. An auxiliary work surface is also included in the form of a pull out tray 94 that has a surface 96 and slides into the work surface and storage unit 56 just below the top surface 62. The tray 94 is extendable, retractable and can generally be placed in any position between its retracted and extended position from either side of the work surface and storage unit 56. Because the pull out tray 94 may be utilized from either side of the workstation 10, a surface 96 that may be used for manipulating a mouse 100 (FIG. 2) for the computer 30 (FIG. 13), or other peripheral device, for example, may be created on either side of the workstation 10. The pull out tray 94 provides yet another user adjustable feature of the workstation 10.

The cassette bins 70, 72 depicted in the cassette assembly 82 shown in FIG. 1, may be easily interchanged with other-sized bins to create differently configured cassette assemblies. Although such a reconfigurable and interchangeable cassette assembly may be used in a variety of applications, an example of interchanging cassettes for a workstation 10 configured for use in a medical environment will now be discussed.

The need for exchanging a cassette assembly 82 may occur when a medical professional in a hospital needs to dispense medication on patient rounds. In such a scenario, the medical professional may need to replenish medications, such as prescription or non-prescription drugs or other medical supplies, from a cassette bin 70, 72. Instead of the medical professional having to deliver the entire workstation 10 back to a hospital pharmacy or nursing station for re-supply, the user may simply bring a replenished cassette assembly to the workstation 10 and exchange the empty cassette assembly 82 for a cassette assembly with replenished cassette bins 70, 72. With continued reference to FIG. 1, in the event that the medical professional must leave the workstation 10 for any reason, the cassette assembly 82 may be locked in the workstation 10. The modular cassette assembly 82 allows a user to take advantage of a full range of benefits associated with using such a workstation 1 0, such as a time savings in dispensing medications, interchangeable and lockable cassette bins 70, 72 within a cassette assembly 82.

With continuing reference to FIG. 1, the cassette assembly 82 includes a plurality of pull-out cassette bins 70, 72, which may be provided on multiple levels of the cassette assembly 82. The workstation 10 includes a security system for preventing unauthorized access to the cassette bins 70, 72, while the cassette assembly 82 includes its own security system for securing the bins 70, 72, even while the cassette assembly 82 is not in the workstation 10. The operation of such a system will now be explained.

FIG. 1 depicts the multi-level cassette assembly 82 that supports a cassette tray 102 on each level, while each cassette tray 102 contains a plurality of pull-out cassette bins 70, 72. A lock 110, which is part of an external locking mechanism, is secured in a front face of the cassette assembly 82, although the lock 110 may be located elsewhere on the cassette assembly 82 as desired. While the cassette assembly 82 in FIG. 1 provides two levels, the number of levels (which corresponds to the number of cassette trays) can of course vary without departing from the scope of the invention. The number and size (i.e., width) of the bins can also be varied to best fit the needs of the end-user and particular task. For example, a cassette assembly may have six bins supported on the top level, four bins supported on the middle level and three bins supported on a lower level. The components comprising the cassette assembly are preferably made of a polymer plastic, such as polypropylene, or the like, and can be formed by conventional molding techniques; however a multitude of plastics may be used in their construction and the present disclosure is not limited to any particular plastic or material.

FIG. 1 depicts the lock 11 0 that locks the cassette trays 102 and hence the cassette bins 70, 72 in the cassette assembly 82. This lock 110 is designed to lock the cassette trays 102 when the cassette assembly 82 is removed, i.e., external, from the medical workstation, which is why the lock is called an “external locking mechanism.” An internal locking mechanism in the frame assembly of the storage unit 56 secures the cassette trays 102 when the cassette assembly 82 is inserted in the medication workstation, which will be explained below. In order to extract the cassette assembly 82 from the workstation 10, the release prongs 112, 114 are squeezed together by a user. Upon squeezing such release prongs 112, 114 together and then pulling, the entire cassette assembly 82 may be removed from the workstation 10 in one unit. However, as stated above, the lock 110 still secures the cassette trays 102 within the cassette assembly 82. The internal locking mechanism locks the cassette assembly 82 within the workstation 10. U.S. Pat. No. 5,673,983 (Carlson et al.), which is assigned to the assignee of the subject invention and hereby incorporated by reference, further explains the cassette assembly 82 and cassette bins 70, 72 utilized in the teachings of the present disclosure.

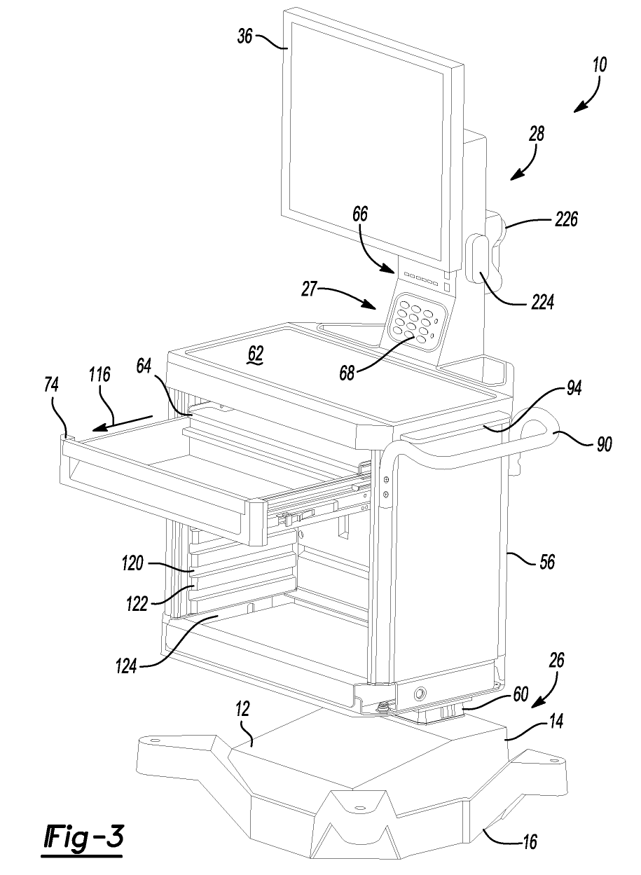

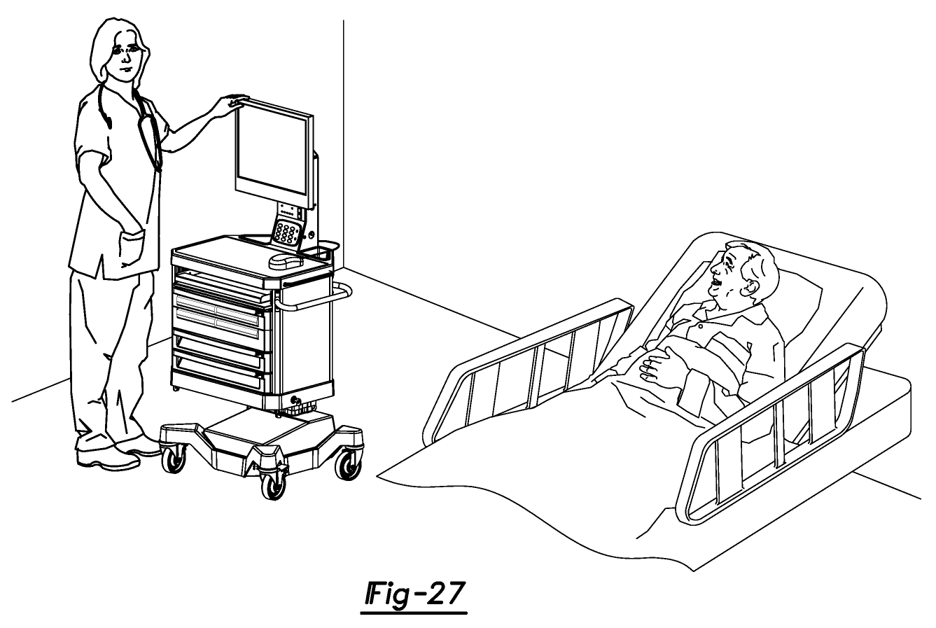

The workstation 10 is equipped with a touch pad 68 (FIGS. 2 and 3), which locks the drawers 74-80 (FIG. 2) and cassette assembly 82 (FIG. 1) depending upon how the workstation 10 is configured. While FIG. 1 depicts a workstation 10 equipped with a single cassette assembly 82, a workstation may be equipped with a cassette assembly and additional drawers, as depicted in FIG. 27, which are not part of the cassette assembly 82. FIG. 2 depicts a workstation 10 with drawers 74-80, which may be used for storage.

Continuing with reference to FIG. 1, the keyboard compartment 84 is depicted in its retracted and stowed position, where it may be locked along with the cassette assembly 82. A computer keyboard may be stored in the keyboard compartment 84. Although not specifically depicted, to move the keyboard compartment 84 to its extended, use position, in accordance with directional arrow 116 (FIG. 3), a user simply places his or her hand within a finger groove and pulls away from the work surface and storage unit 56. The keyboard compartment 84 traverses in a horizontal groove 120 or valley created by a series of alternating protrusions 122. Together the alternating protrusions 122 and grooves 120 create a corrugated effect, as depicted in FIGS. 3 and 14. FIG. 2 depicts a non-locking, pull-out keyboard tray 64, in contrast to the lockable keyboard compartment 84 of FIG. 1. As such, the keyboard tray 64 of FIG. 2 provides quick, pull-out access to a computer keyboard, while the keyboard compartment 84 of FIG. 1 provides the ability to completely conceal and lock a keyboard.

Continuing with reference to FIG. 1, depicting a cassette assembly 82, and FIGS. 2 and 3, depicting drawers 74-80, the modularity of the workstation 10 becomes evident. That is, a different cassette or drawer configuration may be inserted in the cavity 124 (FIG. 3). For instance, a single large drawer, or multiple shallow drawers may be configured in combination with or as an alternative to the cassette assembly 82, depending upon the specific application. As a further alternative, the cavity 124 may house swinging doors that open as a cabinet. Finally, a compartment below the storage cavity 124 presents a space to house a computer 30 to work in conjunction with the keyboard (not shown), computer monitor 36, and, optionally, the control unit 27.

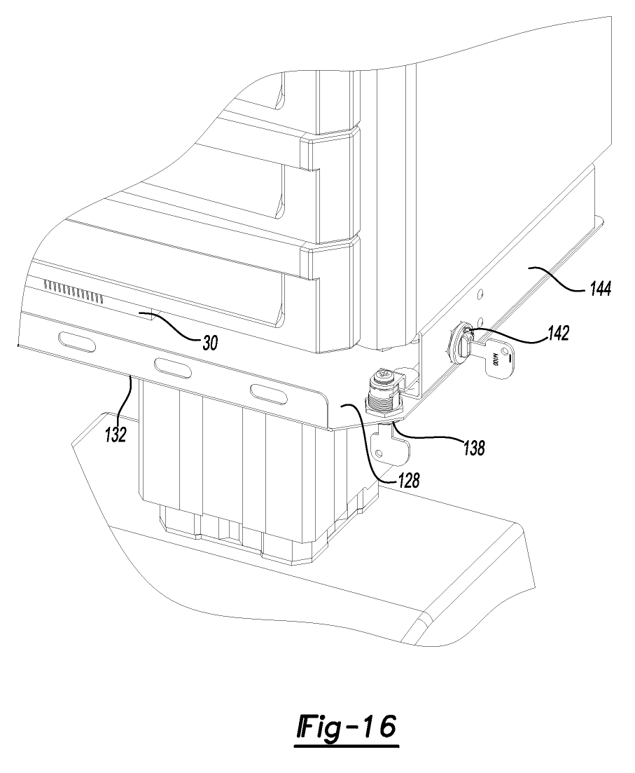

As best depicted in FIGS. 13-15, a computer 30 may be located in computer compartment 126, which is disposed below the cavity 124 housing drawers and/or a cassette assembly 82 (FIGS. 1 and 2). Regarding applicable computers that are suitable for use with the workstation 10, it should be noted that the workstation 10 is not limited to any particular brand or type of computer. For example, if the workstation 10 is being used in a hospital, whatever approved or preferred brand or type of computer that such hospital utilizes may be incorporated in the workstation 10. More specifically, as an example, the computer 30 may be a laptop computer or a computer 30 that lies flat on the computer shelf 128, which is depicted in FIGS. 16, 17 and 21. As an alternative, the workstation may incorporate an “all-in-one”-type computer, like a tablet PC, for example, that is configured to be mounted at the monitor assembly 28, such as where the monitor 36 is mounted in FIG. 2.

With reference to FIG. 21 a computer 30 is situated next to a DC/DC converter 130 on a computer shelf 128 below the storage cavity 124. The computer 30 and DC/DC converter 130 are protected by a bottom frame 132. Additionally, a cross member 134 (FIG. 15) is securely fastened to the front of the bottom frame 132, which is an angled part that covers and protects a front portion of the computer 30 and DC/DC converter 130. A deep shroud 136 (FIG. 15) covers the computer 30, DC/DC converter 130, bottom frame 132, and cross member 134 and acts as a protective cover for the computer 30 and DC/DC converter 130. In addition to the deep shroud 136 providing protection, the computer 30 and DC/DC converter 130 are securely held against the computer shelf 128. This may be accomplished by using Velcro, metal, fabric or plastic strapping (not shown) to reduce or eliminate movement or vibration experienced during transportation of the workstation 10.

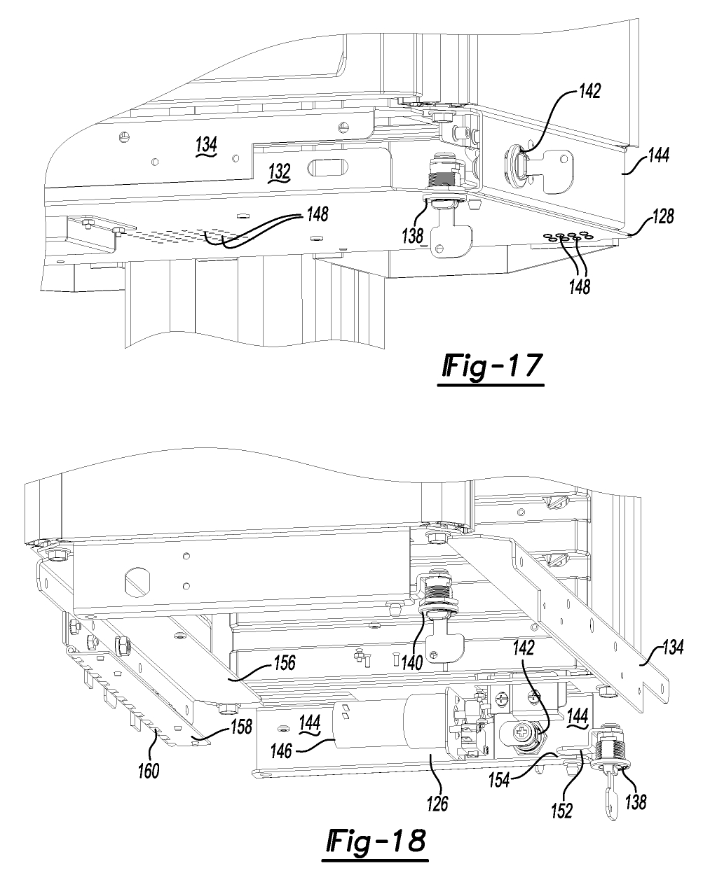

FIGS. 16-19 depict views showing aspects of the computer compartment 126 such as a right lock 138 and a left lock 140, and the computer shelf 128 that supports the computer 30 and the DC/DC converter 130. Also shown are the cross member 134 and a deep shroud 136. Turning to FIG. 17, the right lock 138 is depicted in the computer shelf 128 in a locked position. Together, the left lock 140 (FIG. 18) and right lock 138 securely hold the computer shelf 128 in a generally horizontal position. Turning to FIG. 18, when the locks 138, 140 are turned by a key to their locking positions, a lock bar 152 of the right lock 138, as an example, secures over a flange 154 of the right frame member 144. The left lock 140 works in a similar fashion.

The computer shelf 128 is mounted in a rear of the work surface and storage unit 56 between a top hinge bracket 156 and a bottom hinge bracket 158 of a hinge 160 (FIG. 18). With such a construction, the computer 30 and DC/DC converter 130 may be installed and removed from a bottom of the storage unit 56 by lowering the computer shelf 128 using the hinge 160. Computer shelf air vents 148 (FIG. 17) are located in a rear of the computer shelf 128 to provide ventilation to the computer 30 and DC/DC converter 130. Corresponding air vents are located in the opposing corner and center of the computer shelf 128. In addition to the computer shelf air vents 148, a computer compartment fan 150 is depicted in FIG. 21. The fan 150 provides forced ventilation for the computer 30 and DC/DC converter 130. As an example, the fan 150 may exhaust warmed air, while cooler air is drawn in through the air vents 148.

Referring to FIGS. 18-20, an electrically powered locking mechanism is shown located against an interior of the right frame member 144. The locking mechanism is activated by the gear motor 146 and controls the locking and unlocking of the drawers 74-80 and cassette assembly 82, when the storage unit 56 is so equipped.

FIGS. 17-20 show a manual override lock 142 that permits a user to bypass the powered locking mechanism to unlock the drawers 74-80 and cassette assembly 82 or prevent the drawers 74-80 and cassette assembly 82 from becoming locked.

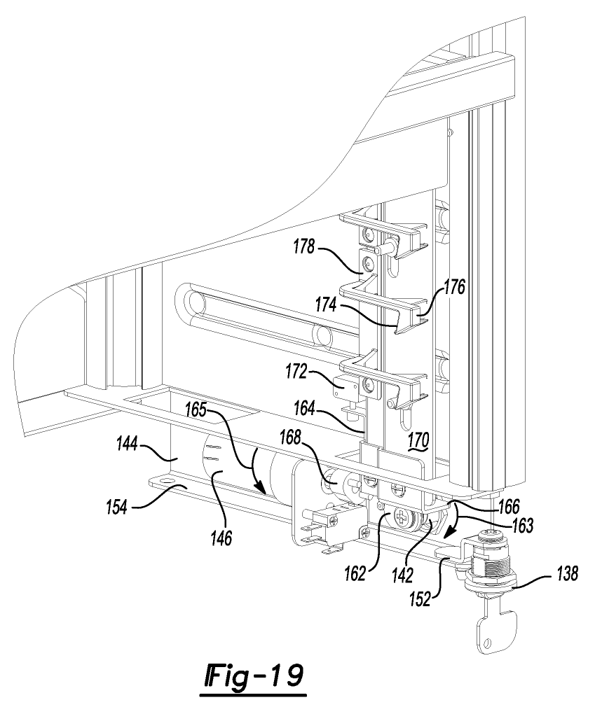

With reference to FIG. 19, an inside view of the right frame member 144 depicting the manual override lock 142 is shown. When the manual override lock 142 is in the “unlock position” where the cam 162 is in a vertical position, the cam 168 of the gear motor 146 is prevented from having any affect on the locking or unlocking of the drawers 74-80 or cassette trays 102 of the workstation 10. In such a state, the drawers 74-80 and cassette trays 102 are essentially maintained in an unlocked state and can be freely opened and/or removed from the workstation 10. In the event that the gear motor 146 is activated and the cam 168 is turned, the cam 168 is unable to contact the lock bar 170, or any parts of the locking mechanism, and thus locking of the drawers 74-80 and cassette trays 102 is prevented.

Continuing with reference to FIG. 19, when the manual override lock 142 is rotated, such as by a key inserted in the lock 142 from the exterior of the workstation 10 (FIG. 17), the cam 162 may be placed into a horizontal or “lock position” (not specifically shown) as understood with reference to directional arrow 163. The cam 162 contacts the switch bar tab 166 and permits the switch bar tab 166, together with the switch bar 164, to be lowered. When in the lock position, the cam 162 enables the gear motor 146 and cam 168 to control the lock or unlock state of the drawers 74-80 and cassette trays 102. Rotation of the cam 168 by the gear motor 146 (as understood with reference to the directional arrow 165) permits the drawers 74-80 and cassette trays 102 (FIGS. 1 and 2) to become locked, or unlocked, as the user desires.

The lock bar 170 and catch bracket 178 move with the switch bar 164. When the cam 168 of the gear motor 146 rotates in accordance with directional arrow 165, the switch bar 164 moves, thereby contacting and moving the lock bar 170, to which the catch bracket 178 is connected. Together, the lock bar 170 and catch bracket 178 may move vertically (as seen in FIG. 19), which causes the locking or unlocking of any drawers 74-80 and cassette trays 102. The lock catch 174 of the lock catch bar 176 secures locking of the drawers 74-80 and cassette trays 102. The catch bracket 178 has at least one lock catch bar 176.

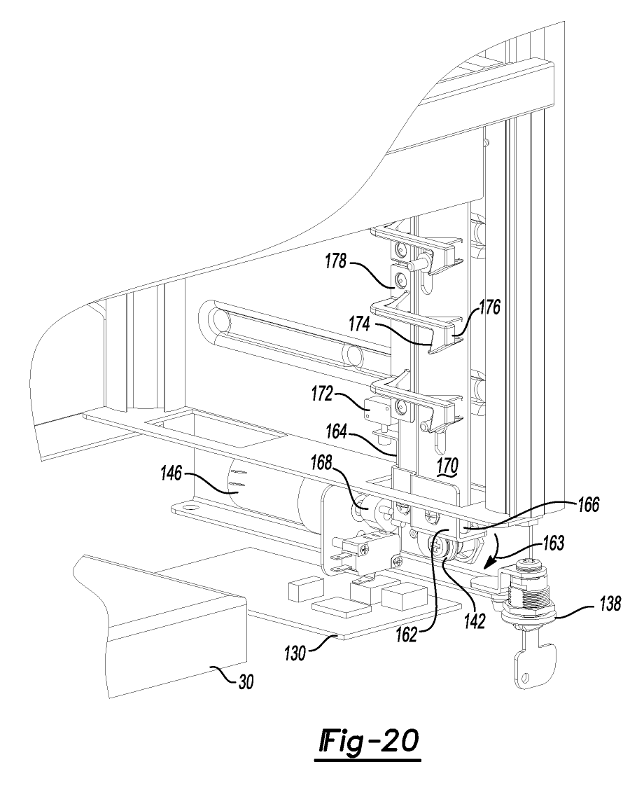

As best depicted in FIGS. 19 and 20, when the cam 168 rotates to the point that the switch bar 164 is raised enough to cause unlocking of the drawers 74-80 and the cassette trays 102 (FIGS. 1 and 2), the limit switch 172 is triggered to deactivate the gear motor 146. In conjunction with command codes to the touch pad 68 (FIG. 6), the drawers 74-80 and cassette trays 102, may be locked. In a locking event, continued rotation of the cam 168 by the gear motor 146 in accordance with directional arrow 165 permits the switch bar tab 166, switch bar 164, lock bar 170 and catch bracket 178 to move downwardly, as depicted in FIG. 19. When the plurality of lock catches 174, connected to the lock catch bar 176, have lowered enough to cause locking of the drawers 74-80 and cassette trays 102 (FIGS. 1 and 2), the limit switch 172 is triggered by the switch bar 164 to deactivate the gear motor 146.

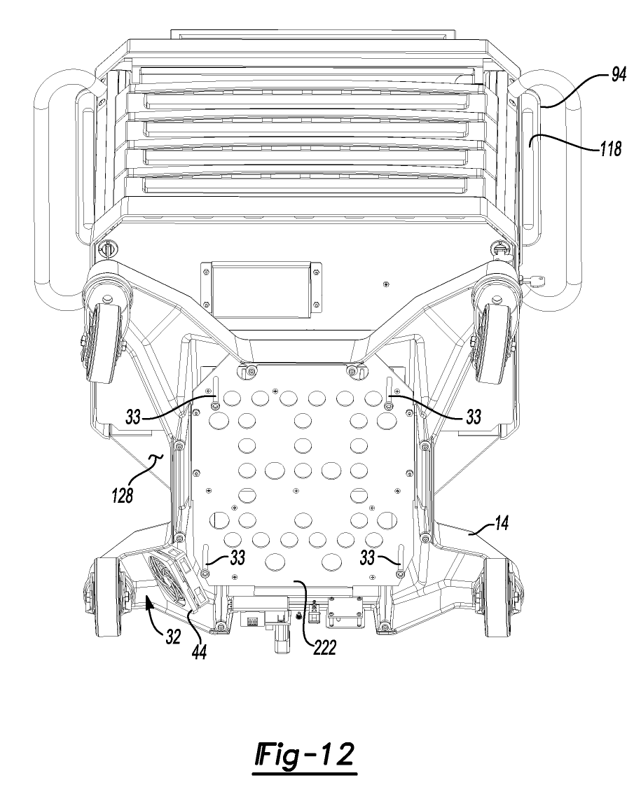

Moving upward in the workstation 10, near the top surface 62, FIG. 2 depicts a pull out tray 94 while, FIG. 12 depicts a finger groove 118 located in the bottom surface of the pull out tray 94 to facilitate positioning of the pull out tray 94, which may be extended from either side of the workstation 10. Also depicted in FIG. 2 is a keyboard tray 64, located just above the drawers 74-80. When not in use, the keyboard tray 64 can be pushed into the work surface and storage unit 56 as a non-locking item.

Best depicted in FIGS. 15 and 21, and continuing with the area proximate the top surface 62, a left storage bin 180 and a right storage bin 182 are located at a rear of the top surface 62 of the workstation 10, on either side of the monitor assembly 28, which provides a mounting location for the monitor 36. Left storage bin 180 inserts into left bin cavity 184, while right storage bin 182 inserts into a right bin cavity 186. The bins 180, 182 are easily removed and inserted to facilitate easy cleaning and re-supply of work-related items. The storage bins 180,182 may be used for a variety of purposes, such as for medical or administrative supplies.

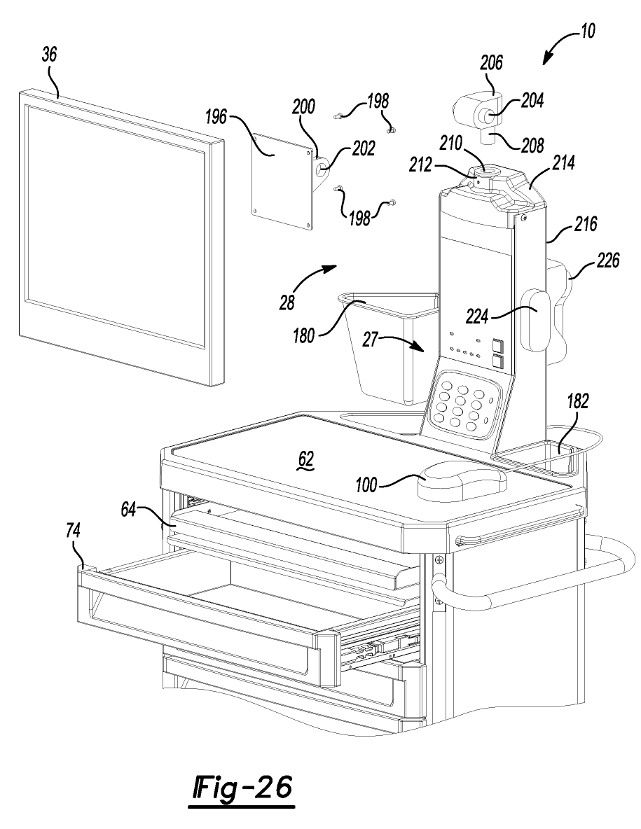

Continuing upward in the workstation 10, the monitor assembly 28 will now be discussed. The monitor assembly 28, to which a computer monitor 36 may attach, is best depicted in FIGS. 1, 2 and 24-26. In a first embodiment depicted only in FIG. 1, the monitor arm 190 may attach proximate to a top surface of the linear actuator. The monitor arm 190 may pivot at a first arm end 188 and at the second arm end, the monitor 36, which may be a standard monitor such as a 15 to 19 inch monitor, attaches. The monitor 36 may pivot about the second arm end, separately from the pivoting first arm end, as will be described shortly in the next embodiment.

FIGS. 2-3, and 24-26 depict an embodiment different from the pivoting arm 190 of FIG. 1. In the alternate embodiment, a fixed monitor assembly 28 attaches to the linear actuator within the work surface and storage unit 56. The linear actuator itself does not pivot, but similar to the first embodiment, the monitor assembly 28 has a pivoting structure to which the monitor 36 attaches to in order to accommodate various positions of the user when the user views the monitor 36. The monitor assembly 28 also houses the control unit 27, with optional card reader 224, and/or optional bar code scanner 226.

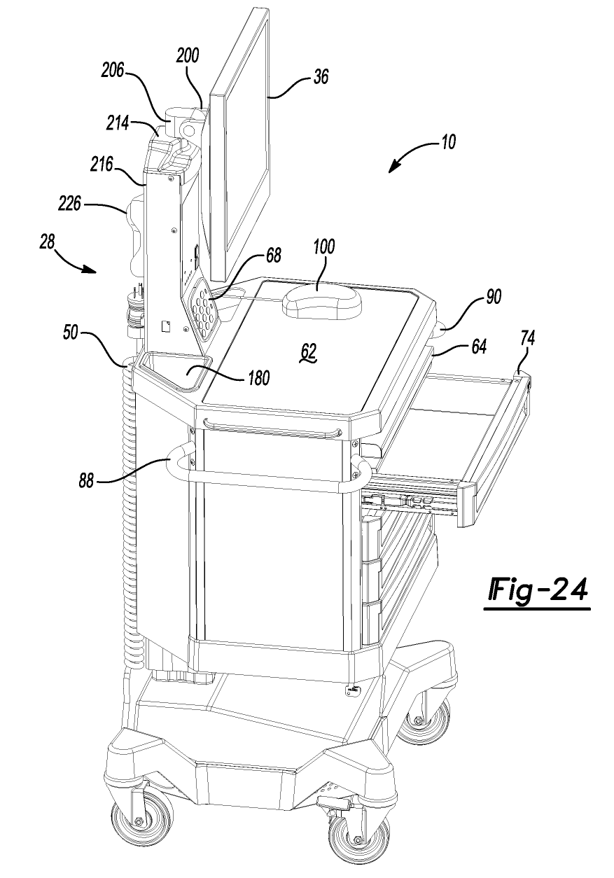

Continuing, FIGS. 24-26 generally depict how the monitor 36 mounts to the monitor assembly 28. The monitor 36 attaches to a monitor plate 196 by traditional fasteners 198, such as screws, rivets, or plastic fasteners through holes in the monitor plate 196. Alternatively, instead of directly fastening to a rigid, one-piece plate 196, the monitor 36 may affix to a plate that permits 360 degree rotation of the monitor 36 in a vertical plane. Such monitor rotation may facilitate viewing of medical charts on the monitor 36 in portrait or landscape mode to best utilize the surface area of the monitor 36 or preference of the user. The monitor plate 196 may have a clevis 200 on its rear, the clevis 200 having a hole 202 for insertion of pins 204 that protrude from either side of a connector bracket 206. The connector bracket 206 may have a connector bracket pin 208 to pass into an insert hole 21 0 of an insert 212 of the top plate 214 which mounts at the top of the monitor assembly 28. The insert 212 is a plug or grommet-like item that is fitted into the top plate 214 of the monitor assembly 28. The top plate 214 and monitor assembly back plate 216 may fasten together with traditional fasteners such as screws, rivets, etc. Although not depicted, the monitor 36 may be affixed with a privacy screen when privacy is desired or the confidentiality of the information displayed on the screen must be maintained.

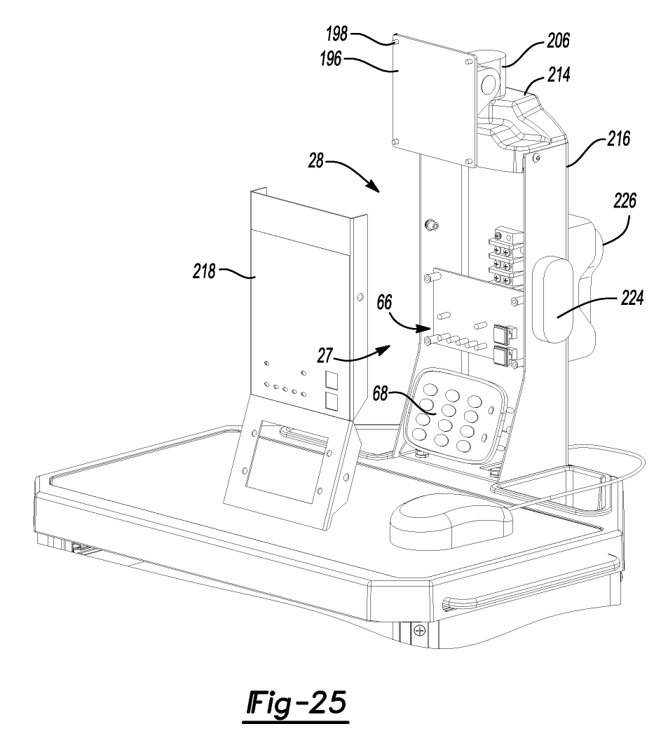

Referencing FIGS. 2 and 25, the control unit 27 incorporates a front panel 218 that houses a series of LEDs 66 and a touch pad 68. The LEDs 66 may be used to light in specific combinations to indicate to a user, the current state of the charge level of the batteries resident in the battery modules 25 in the base unit 12. Other LED patterns may be used to indicate specific states of the workstation 10, such as whether the computer system is currently accessible or inaccessible, or other diagnostic information. The control unit 27 may also include switches to control the adjustable features of the workstation 10.

The touch pad 68 may be used by a user to type in a security code to gain “access” to the computer 30 residing in the workstation 1 0. Here, “access” means the ability for a user to electronically gain access and use the computer 30, and not physical access to the computer 30. Such a security code may correspond to a specific user and permit the ability of a user to use the computer 30, such as having the computer 30 recognize typing from a keyboard. In this form of electronic access, the touch pad 68 may act as a form of security clearance for the individual who desires to use the computer 30 resident in the workstation 10.

Additionally, the touch pad 68 may be used by a user to gain physical access to the workstation and its storage unit, such as the drawers 74-80 and cassette assembly 82 and associated cassette bins 70, 72 (FIG. 1). As an example, when the workstation 10 is left unattended, the user may type in a code at the touch pad 68 to essentially “lock” physical access to the workstation and its drawers or cassettes and/or electronic access to the computer 30. Upon returning to the workstation 10, the user would enter his or her security code to again physically unlock the drawers and cassettes, but also to electronically unlock the computer resident in the workstation 10. In a third key pad use scenario, the touch pad 68 may not provide immediate electronic access to the computer system, but rather the touch pad 68 may be configured to provide electronic access to a security screen on the monitor 36 such that the user is prompted to type his or her security codes or passwords at a computer keyboard. Upon entry of acceptable security codes or passwords, the user may then be granted full electronic access to the computer and/or physical access to the cassette assembly and/or drawers.

In addition to controlling electronic access to the computer 30 and physical access to the cassettes and/or drawers of the workstation, the touch pad 68 or other switches included in the control unit 27 may control the position of the linear actuator and govern the height to which the work surface and storage unit 56 vertically traverses as a “memory function.” In such a scenario, the touch pad 68 or switches would be connected to a memory such that the preferred position of the linear actuator for a particular user could be stored in memory and when a user code was successfully entered, the linear actuator would automatically adjust.

In another application of the touch pad 68, after a user uses the touch pad 68 to gain physical access to the drawers 74-80 and cassette assembly 82, electronic access, as opposed to physical access, to the computer 30 may be possible upon entry of another code, thus different codes may be required for different types of access.

Finally, the control unit 27 may also provide a remote power switch by which a user may turn on or turn off the computer 30 housed within the computer compartment 126 (FIG. 15).

Although a variety of styles of touch pads may be used, such as a membrane type with a controller, an RF card reader such as is available from CompX Corporation may also be used for the application. Still other methods may be used to gain electronic access to the computer 30 or to unlock the drawers and cassettes of the workstation 10. With reference to FIG. 4, one such other method is an optional bar code scanner 226 shown on the rear of monitor assembly 28, and available from Metrologic Corporation.

The bar code scanner 226 may be used, for example, as a security measure for electronic access to the computer. Upon scanning a bar code of an approved user, such as from a security card, immediate computer usage may be permitted, or such scanning may permit a user to then enter security codes, passwords, etc. via the computer keyboard to gain electronic and physical access to the workstation 10. Additionally, the cassettes and drawers may be locked and unlocked when a user scans his or her ID badge barcode with the bar code scanner 226. With reference to FIG. 2, the control unit 27 may also incorporate an identification card reader 224, such as a magnetic stripe card reader, a radio frequency identification card reader (“RFID”), or an optical card reader. In lieu of such a card reader, a flat screen, touch-sensitive security panel, or a biometric security panel such as a fingerprint reader, retinal scanner, or voice recognition access system may be employed by the control unit 27.

While the workstation 10 is applicable in a variety of industrial settings, the advantages are easily set forth when the workstation is viewed in a medical environment. For instance, a nurse or other medical professional of a hospital staff may require access to patient information on a real-time basis at the point of application of medical care, such as with a patient while a medical professional makes rounds. When at a point of application, accessing patient information or updating patient data may be entered real-time, into a centralized computer system or stored to the on-board computer 30, from the workstation 10.

An example of accessing patient information may consist of a professional scanning a barcode on a patient armband with the bar code scanner 226 (FIG. 2) to view the latest information or entire medical history pertaining to a patient. Then, the professional may update that information by immediately typing information into the computer 30. Another way to update the patient history is to scan a barcode on a medication container, which may then electronically update the patient's history with the medication dispensed and its dosage. Still yet, before dispensing a medication to a patient, the computer 30 may provide a screen alert on the monitor 36 in the event that a medication scanned prior to dispensing to the patient, may interact with a medication that the patient is currently taking.

While the workstation 10 may be used as a point of application device, the workstation may be configured to other computer peripheral devices by access ports on the workstation 10. Regarding access ports for computer peripherals, in accordance with “HIPAA,” or the Health Insurance Portability Accountability Act, some computer ports may not be permitted to be exposed. Such ports that are not permitted to be exposed, such as on the exterior of the monitor assembly 28 (FIG. 2), may be placed within the cavity 124 (FIG. 3) and still retain their ease of accessibility. Wireless peripherals may be tethered to the workstation 10 to ensure their physical security while wired peripherals may be desired to limit battery replacement of individually powered peripheral devices, such as a wireless mouse, keyboard, etc.

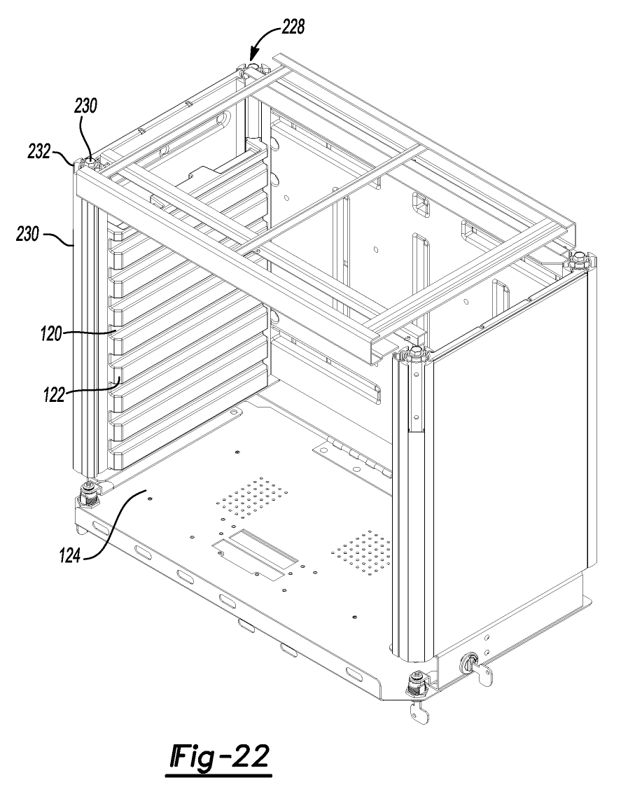

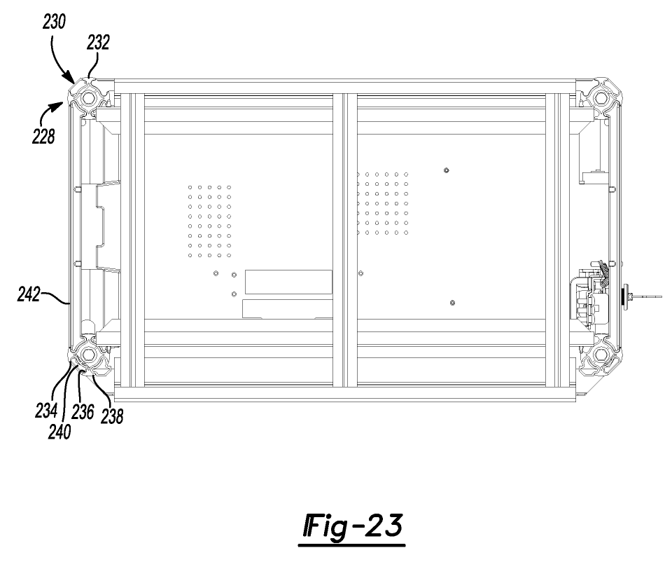

FIGS. 22 and 23 depict views of the work surface and storage unit 56. Specifically, FIG. 22 is a top front perspective view of the internal storage cavity 124 void of any drawers or any cassette assembly. Furthermore, FIG. 22 depicts corrugations formed by the grooves 120 and protrusions 122, which provide the track for guiding the drawers 74-80 (FIG. 2) in and out of the cavity 124. FIG. 22 also depicts, along with FIG. 23, a “star” type of modular interlocking mechanism 228. More specifically, the workstation 10 may utilize a modular storage and support assembly with a platform system that includes vertically disposed support posts 230. The support posts 230 have an extended tubular body 232 and a plurality of symmetrically spaced, radially extending flanges 234 running the length of the tubular body 232. Each flange 234 has a first portion 236 extending radially from the post 230 and a second portion 238 at the terminal end of the first portion 236. A slot 240 is defined between each pair of adjacent flanges for receiving vertical panels 242 or other inserts. U.S. Pat. No. 5,915,803 (Daugherty et al.), which is assigned to the assignee of the subject invention and hereby incorporated by reference, discloses a modular storage and support assembly that includes vertically disposed support posts. More specifically, columns 7 and 8 of U.S. Pat. No. 5,915,803 set forth an introduction to the interlocking support features.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A modular computer workstation, comprising:
a base unit comprising a cover and a pan, the cover and pan cooperable to define a cavity therebetween;
a power unit housed within the cavity of the base unit, the power unit comprising a charging system and at least one rechargeable battery, the power unit operable to power the workstation independent of the presence or operational condition of the at least one rechargeable battery;
a support unit mounted to and extending vertically upward from the base unit;
a work surface and storage unit mounted on the support unit and above the base unit, the work surface and storage unit comprising a generally flat work surface at an upper end and a computer compartment at a lower end, the work surface and storage unit further comprising a modularly configurable storage compartment located intermediate the work surface and the computer compartment, the storage compartment housing a lockable, enclosed keyboard compartment;
a monitor assembly mounted to the support unit and above the work surface and storage unit, the monitor assembly comprising a monitor and a monitor mounting structure, the mounting structure enabling the monitor to pivot about at least one axis;
a control unit housed within one of the monitor assembly or the work surface; and
a computer housed within the computer compartment.

2. The modular workstation of claim 1 wherein the base unit further comprises:
a plurality of wheels, wherein at least two of the wheels pivot and at least two of the wheels have a lock to prevent rotation thereof; and
at least one handle mounted to the work surface and storage unit.

3. The modular workstation of claim 1, the support unit comprising:
a first telescoping member attached to the base;
a second telescoping member within which the first telescoping member is disposed and to which the work surface and storage unit is attached; and
a height adjustment mechanism comprising one of an adjusting bar gas spring located within the support unit and an electric motor located within the support unit.

4. The modular workstation of claim 1, the support unit further comprising:
a plurality of wires within the support unit, the wires running from the power unit within the base unit through the support unit to the monitor assembly.

5. The modular workstation of claim 1, wherein the control unit further comprises a plurality of status lights to indicate a charge level of the at least one rechargeable battery.

6. The modular workstation of claim 1, the monitor assembly further comprising an input device operable with the computer, the input device being one of a bar code scanner, a card reader, and a touch panel.

7. The modular workstation of claim 1, wherein the monitor mounting structure enables the monitor to rotate within a plane lying perpendicular to the work surface.

8. The modular workstation of claim 1, wherein the monitor assembly further comprises a privacy screen affixed to the monitor.

9. The modular workstation of claim 1, wherein the modularly configurable storage compartment further comprises:
a cassette assembly, the cassette assembly being removeable from the work surface and storage unit by a manually operated release mechanism.

10. The modular workstation of claim 9, wherein the cassette assembly further comprises at least one cassette tray.

11. The modular workstation of claim 10, wherein the cassette tray further comprises at least one cassette bin.

12. The modular workstation of claim 11, wherein the cassette assembly further comprises a lock operable to secure the at least one cassette bin within the at least one cassette tray and the at least one cassette tray within the cassette assembly.

13. The modular workstation of claim 9, wherein the work surface and storage unit further comprises an electrically powered lock mechanism for securing the cassette assembly within the work surface and storage unit.

14. The modular workstation of claim 1, wherein the keyboard compartment comprises a drawer that may be extended from the storage compartment to a use position and retracted into the storage compartment to a stowed position.

15. The modular workstation of claim 1, wherein the work surface and storage unit further comprises at least one storage bin located in a top surface adjacent to the work surface.

16. The modular workstation of claim 1, wherein the work surface and storage unit further comprises an electrically powered lock mechanism, and the modularly configurable storage compartment houses a plurality of drawers, the drawers being lockable within the work surface and storage unit by the lock mechanism.

17. The modular workstation of claim 16, wherein the lock mechanism comprises an electric motor, a catch bracket, a catch bar, and a lock catch located at an end of the catch bar, the electric motor operable to move the catch bracket, catch bar and lock catch to catch and lock the drawers.

18. The modular workstation of claim 17, the lock mechanism further comprising:
an override lock accessible from outside of the work surface and storage unit and operable to override the operation of the electric motor.

19. The modular workstation of claim 1, wherein the computer compartment comprises a shelf hinged at one end so as to permit access to the computer compartment and a lock for selectively locking the shelf and preventing access to the computer compartment.

20. The modular workstation of claim 19, wherein the shelf comprises at least one vent permitting air to pass through the shelf.

21. The modular workstation of claim 20 further comprising a fan mounted to the shelf, the fan operable to create airflow through the at least one vent.

22. The modular workstation of claim 1, wherein the storage compartment comprises:
a plurality of drawers;
a locking mechanism for locking the drawers comprising a catch bracket; and
a manual override lock accessible from outside of the work surface and storage unit and operable to override the locking mechanism, the override lock comprising a cam that engages the catch bracket to enable locking and unlocking of the drawers.

23. The modular workstation of claim 1, wherein the storage compartment comprises:
a plurality of drawers;
a lock bar;
a switch bar tab attached to the lock bar;
a gearmotor; and
a cam attached to the gearmotor, wherein the cam contacts the switch bar tab to move the lock bar into lock and unlock positions to lock and unlock the drawers.

24. The modular workstation of claim 23, further comprising:
a switch bar; and
a limit switch, wherein the switch bar contacts the limit switch to activate and deactivate the gear motor.

25. The modular workstation of claim 1, wherein the control unit comprises a user accessible input device that controls access to the modular workstation, the input device being at least one of an alpha/numeric keypad, a numeric keypad, an alphabetic keypad, and a biometric access device.

26. The modular workstation of claim 1, wherein the control unit further comprises a plurality of LEDs for indicating at least one of battery charge level and workstation accessibility or inaccessibility.

27. The modular workstation of claim 1, wherein the control unit comprises a user accessible input device for user code acceptance to grant access to the storage compartment and the computer compartment.

28. The modular workstation of claim 1, the support unit comprising a linear actuator and the control unit comprising a user accessible input device that permits height adjustment of the work surface upon entry of a user code.

29. The modular workstation of claim 1, wherein the control unit comprises a power switch to control power to the computer.

30. A modular computer workstation, comprising:
a base unit adapted to house a power unit;
the power unit comprising a charging system and at least one rechargeable battery module;
a support unit mounted to and extending vertically upward from the base unit;
a work surface and storage unit mounted on the support unit and above the base unit, the work surface and storage unit comprising a generally flat work surface and a modularly configurable storage compartment located below the work surface, the storage compartment adapted to accommodate one or more of a drawer, tray, shelf, storage cassette and storage bin;
a monitor assembly mounted to the support unit and above the work surface and storage unit, the monitor assembly comprising a monitor and a monitor mounting structure; and
a control unit housed within one of the monitor assembly or the work surface.

31. The modular workstation of claim 30, wherein the work surface and storage unit further comprises a computer compartment.

32. The modular workstation of claim 31, wherein the computer compartment further comprises:
a hinged access panel attached along the bottom of the storage compartment and operable to provide access to the computer compartment from a bottom of the storage compartment.

33. The modular workstation of claim 32, wherein the hinged access panel further comprises a keyed lock to prevent unauthorized access to the computer compartment.

34. The modular workstation of claim 30, wherein the base unit comprises:
a base cover; and
a ventilated base pan, wherein the base cover and ventilated base pan define a cavity within which the power unit resides.

35. The modular workstation of claim 30, wherein the power unit is operable to power the workstation independent of the presence or operational condition of the at least one rechargeable battery module.

36. The modular workstation of claim 30, further comprising a computer, wherein the charging system is operable to charge the at least one battery module regardless of either an operational or a non-operational state of the computer.

37. The modular workstation of claim 30, wherein the at least one rechargeable battery module comprises a plurality of individual batteries.

38. A modular computer workstation, comprising:
a base unit adapted to house a power unit;
the power unit comprising a charging system and a plurality of battery modules, each battery module comprising a plurality of rechargeable batteries, the charging system comprising a separate control circuit for charging each battery module;
a support unit mounted to and extending vertically upward from the base unit;
a work surface and storage unit mounted on the support unit and above the base unit, the work surface and storage unit comprising a generally flat work surface and a modularly configurable storage compartment located below the work surface;
a monitor assembly mounted to the support unit and above the work surface and storage unit, the monitor assembly comprising a monitor and a monitor mounting structure; and
a control unit housed within one of the monitor assembly or the work surface.

39. The modular workstation of claim 38, further comprising:
a computer; and
a computer compartment within which the computer resides, the computer compartment accessible from a bottom of the work surface and storage unit.

40. The modular workstation of claim 39, further comprising:
a hinged access panel at a bottom of the work surface and storage unit that provides access to the computer.

41. The modular workstation of claim 40, wherein the hinged access panel further comprises a keyed lock to prevent unauthorized access to the computer compartment.

42. The modular workstation of claim 41, wherein the control unit further comprises a power switch to control power to the computer.

43. The modular workstation of claim 38, wherein the modularly configurable storage compartment comprises:
at least one drawer; and
a removable cassette assembly;
and wherein a motor-driven locking mechanism is operable to lock the plurality of drawers and the cassette assembly within the modular workstation.

44. The modular workstation of claim 43, wherein the cassette assembly further comprises a hand-operated release mechanism operable to disengage the cassette assembly from the work surface and storage unit and permit its removal from the modular workstation.

45. The modular workstation of claim 43, wherein the cassette assembly comprises a plurality of cassette bins.

46. The modular workstation of claim 45, wherein the cassette assembly further comprises a lock to lock the plurality of cassette bins within the cassette assembly.

47. The modular workstation of claim 38, wherein the work surface and storage unit further comprises a keyboard compartment comprising a drawer that can be retracted within the work surface and storage unit when in a stowed position.

48. The modular workstation of claim 47, wherein the keyboard compartment is lockable with a motor-driven locking mechanism.

49. The modular workstation of claim 38, wherein the control unit comprises a user input device for controlling access to the modular workstation.

50. The modular workstation of claim 49, wherein the user input device is selected from the group consisting of a bar code scanner, a magnetic stripe card reader, a radio frequency card reader, an optical card reader and a biometric access device.
